(19) United States
(12) Patent Application Publication
(10) Pub. No.: US 2010/0152089 A1
(43) Pub. Date: Jun. 17, 2010

(54) Liquid, Highly Foaming Detergent or Cleaning Agent with Stable Viscosity

(76) Inventors: Carine Wattebled, Dusseldorf (DE); Sören Hölsken, Dusseldorf (DE); Bernhard Guckenbiehl, Koln (DE)

Correspondence Address: Henkel Corporation, 10 Finderne Avenue, Bridgewater, NJ, 08807, US

(21) Appl. No.: 12/639,249

(22) Filed: Dec. 16, 2009

Related U.S. Application Data
(63) Continuation of application No. PCT/EP2008/054961, filed on Apr. 24, 2008.

(30) Foreign Application Priority Data
Jun. 18, 2007 (DE) 10 2007 028 509.6

(51) Int. Cl. C11D 1/02; C11D 3/60; C11D 3/33; C11D 3/32

(52) U.S. Cl. 510/337

(57) ABSTRACT

Liquid washing or cleaning agent comprising a surfactant mixture having at least one anionic surfactant and an alkylpolyglucoside (APG), a foam booster, and an electrolyte, the ratio of anionic surfactant to electrolyte being higher than 10:1. Washing or cleaning agents of this kind are high-foaming and have a viscosity that permits the use thereof for hand laundering.

### CROSS REFERENCE TO RELATED APPLICATIONS

The present application is a continuation of International Application No. PCT/EP2008/054961 filed 24 Apr. 2008, which claims priority to German Application No. 10 2007 028 509.6, filed 18 Jun. 2007.

The invention relates to a washing or cleaning agent containing a surfactant mixture and a foam booster. The invention also relates to the use of the washing or cleaning agent.

Liquid washing or cleaning agents for use in automatic washing machines, especially in washing machines having a horizontal washing drum such as those that are usual in Europe, contain a foam inhibitor that controls or reduces the formation of suds during the washing procedure. A high degree of foaming of the washing or cleaning agent that is used can result in “overfoaming”, which in turn can cause a loss of active ingredients and thereby a reduction in washing performance. The large quantities of foam reduce the mechanical force to which the textiles are subjected in such washing machines, and thereby also decrease washing performance.

In some countries, for example, in many North African, Arab, or Asian countries, laundry is still usually washed by hand or with simple top-loader washing machines with short washing times (about 12 minutes). Traditionally, powdered washing agents are typically made available for this purpose. In recent years, however, liquid washing or cleaning agents have also become more and more popular for hand laundering of textiles. For hand washing or when simple top-loader washing machines are used, conversely, a great deal of foaming is desirable.

In order to achieve sufficient foaming and foam stability, so-called “foam boosters” are added to these washing or cleaning agents. The addition of these foam boosters to liquid washing or cleaning agents often results in a massive increase in the agent's viscosity, which prevents easy and accurate dispensing and rapid dissolution of the washing or cleaning agent together with rapid foaming.

It is an object of the present invention to make available a liquid, high-foaming washing or cleaning agent that exhibits acceptable viscosity and stable foam.

This object is achieved by a washing or cleaning agent containing a surfactant mixture that encompasses at least one anionic surfactant and an alkylpolyglucoside (APG), a foam booster, and an electrolyte, the ratio of anionic surfactant to electrolyte being higher than 10:1.

It has been found, surprisingly, that the addition of a small quantity of electrolyte, in terms of the total anionic surfactant content, is sufficient to adjust the viscosity in liquid washing or cleaning agents to acceptable values. “Acceptable viscosity values” are, for purposes of this invention, viscosity values for the washing or cleaning agents of less than 10,000 mPas, and by preference less than 5,000 mPas (Brookfield LVT-II viscosimeter at 20 rpm and 20° C., spindle 3). Washing or cleaning agents in which the ratio of anionic surfactant to electrolyte is 10:1, or is lower than this ratio, possess considerably higher viscosity values.

It is preferred that the ratio of anionic surfactant to electrolyte be higher than 12:1, and very particularly preferably higher than 15:1.

It has been found that the viscosity can be further reduced by increasing the ratio of anionic surfactant to electrolyte.

It is further preferred that the ratio of foam booster to electrolyte be from 1:2 to 1:0.5, by preference 1:1.2 to 1:0.75, and very particularly preferably from 1:1 to 1:0.8.

It is also preferred that the ratio of APG to electrolyte be from 1:1 to 5:1, by preference 1.5:1 to 4:1, and very particularly preferably from 2:1 to 3:1.

It has further become evident, surprisingly, that it is advantageous in terms of foam behavior and the viscosity of the washing or cleaning agent if the foam booster and/or the APG is used at specific quantitative ratios with respect to the electrolyte.

It is preferred that the electrolyte be selected from the group made up of alkali metal compounds, alkaline-earth metal compounds, ammonium compounds, and mixtures thereof. It is particularly preferred in this context that the electrolyte be selected from the group made up of organic alkali metal salts, inorganic alkali metal salts, organic alkaline-earth metal salts, inorganic alkaline-earth metal salts, organic ammonium salts, inorganic ammonium salts, and mixtures thereof. In a very particularly preferred embodiment, the electrolyte is sodium chloride. Even in small quantities, these electrolytes can considerably reduce the viscosity of the washing or cleaning agent.

It is further preferred that the foam booster be selected from the group of the alkylaminocarboxylic acid salts, fatty acid amides, fatty acid alkanolamides, betaines, sulfobetaines, polymeric compounds, and mixtures thereof. A particularly preferred foam booster is the sodium salt of N-(carboxyethyl)-N-dodecyl-beta-alanine.

In a preferred embodiment, the washing or cleaning agent is free of fatty acid soaps, since these may reduce the volume of foam.

In a very particularly preferred embodiment, the liquid washing or cleaning agent further contains monopropylene glycol. It has been found, surprisingly, that the foam behavior, in particular the foam volume, of the liquid washing or cleaning agents can be intensified by the addition of monopropylene glycol.

In order to enhance the cleaning performance on bleachable stains, it is preferred that the liquid washing or cleaning agent further contain 0.0005 to 0.1 wt %, more preferably 0.001 to 0.075 wt %, and most preferably 0.005 to 0.05 wt % of a photobleaching agent.

In a further aspect, the invention relates to the use of the washing or cleaning agent for washing and/or cleaning textile fabrics.

The invention also relates to the use of monopropylene glycol, in a liquid washing or cleaning agent encompassing a) a surfactant mixture that encompasses at least one anionic surfactant and an alkylpolyglucoside (APG), b) a foam booster, and c) an electrolyte, the ratio of anionic surfactant to electrolyte being higher than 10:1, to intensify the foam formation of the liquid washing or cleaning agent.

A washing or cleaning agent according to the present invention contains a surfactant mixture of at least one anionic surfactant and alkylpolyglucoside (APG), a foam booster, and an electrolyte. In order to obtain washing or cleaning agents having acceptable viscosity, it is critical in this context that the ratio of anionic surfactant to electrolyte be higher than 10:1.

Liquid washing or cleaning agents contain an electrolyte as a constituent that is essential to the invention. This electrolyte is by preference an alkali metal compound, an alkaline-earth metal compound, an ammonium compound, or a mixture thereof. Very particularly preferably, the electrolyte is an organic alkali metal salt, an inorganic alkali metal salt, an organic alkaline-earth metal salt, an inorganic alkaline-earth metal salt, an organic ammonium salt, an inorganic ammonium salt, or a mixture thereof. Preferred inorganic alkali metal or alkaline-earth metal salts encompass sodium chloride, potassium chloride, calcium chloride, magnesium chloride, sodium sulfate, potassium sulfate, calcium sulfate, magnesium sulfate, sodium hydrogen sulfate, potassium hydrogen sulfate, sodium (hydrogen)carbonate, potassium (hydrogen)carbonate, calcium carbonate, magnesium carbonate, sodium phosphate, disodium (hydrogen)phosphate, sodium dihydrogen phosphate, potassium phosphate, dipotassium hydrogen phosphate, potassium dihydrogen phosphate, calcium phosphate, magnesium phosphate, magnesium dihydrogen phosphate, magnesium hydrogen phosphate, sodium nitrate, potassium nitrate, calcium nitrate, magnesium nitrate, or mixed crystals thereof (sesqui, trona). Preferred ammonium salts encompass ammonium chloride, ammonium nitrate, and ammonium sulfate. Organic salts such as the corresponding acetates, tartrates, lactates, and/or citrates of the alkali metals or alkaline-earth metals, or the corresponding organic ammonium salts, can also be used. Suitable compounds encompass sodium acetate, potassium acetate, sodium tartrate, potassium tartrate, sodium lactate, potassium lactate, sodium citrate, potassium citrate, magnesium acetate, calcium acetate, magnesium citrate, calcium citrate, magnesium lactate, or calcium lactate. It is very particularly preferred that the electrolyte encompass sodium chloride.

These materials, in particular, sodium chloride, not only are inexpensive but also dissolve very readily in water. In addition, many of these materials are odor-neutral.

The quantity of electrolyte is by preference between 0.01 and 5 wt %, more preferably from 0.1 to 3 wt %, even more preferably from 0.5 to 2 wt %, and most preferably from 0.75 to 1.5 wt %.

In addition to the electrolyte, the washing or cleaning agents contain a surfactant mixture of at least one anionic surfactant and alkylpolyglucoside (APG).

Alkylpolyglucosides have the general formula RO(G)ₓ, in which R denotes a primary straight-chain or methyl-branched, especially methyl-branched in the 2-position, aliphatic residue having 8 to 22, by preference 12 to 18 carbon atoms, and G is the symbol denoting a glucose unit having 5 or 6 carbon atoms, by preference glucose. The degree of oligomerization x, which indicates the distribution of monoglucosides and oligoglucosides, is any number between 1 and 10; by preference, x is 1.2 to 1.4. Alkyglucosides are known mild surfactants and are manufactured entirely from renewable raw materials (glucose, for example, from corn starch and fatty alcohol, for example, from coconut oil).

The quantity of APG based on the entire washing or cleaning agent is by preference from 0.1 to 10 wt %, more preferably between 0.5 and 5 wt %, and particularly preferably between 1 and 4 wt %.

Washing or cleaning agents having a viscosity particularly suitable for use as hand washing or hand cleaning agents, and an excellent, stable, foaming capability, are obtained when the ratio of APG to electrolyte is from 1:1 to 5:1, by preference 1.5:1 to 4:1, and very particularly preferably from 2:1 to 3:1.

The surfactant mixture furthermore contains, in obligatory fashion, at least one anionic surfactant. Anionic surfactants that can be used are, for example, those of the sulfonate and sulfate types. Possible surfactants of the sulfonate type include, by preference, C₉₋₁₃ alkylbenzenesulfonates, olefinsulfonates, i.e., mixtures of alkene- and hydroxyalkanesulfonates, and disulfonates, for example, those obtained from C₁₂₋₁₈ monoolefins having an end-located or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis and neutralization. The esters of α-sulfo fatty acids (estersulfonates), e.g. the α-sulfonated methyl esters of hydrogenated coconut, palm kernel, or tallow fatty acids, are likewise suitable.

Further suitable anionic surfactants include sulfonated fatty acid glycerol esters. “Fatty acid glycerol esters” are to be understood as the mono-, di- and triesters, and mixtures thereof obtained during the production by esterification of a monoglycerol with 1 to 3 mol fatty acid, or upon transesterification of triglycerides with 0.3 to 2 mol glycerol. Preferred sulfonated fatty acid glycerol esters include the sulfonation products of saturated fatty acids having 6 to 22 carbon atoms, for example, hexanoic acid, octanoic acid, decanoic acid, myristic acid, lauric acid, palmitic acid, stearic acid, or behenic acid.

Preferred alk(en)yl sulfates include the alkali, and in particular sodium, salts of the sulfuric acid semi-esters of the C₁₂-C₁₈ fatty alcohols, for example, from coconut fatty alcohol, tallow fatty alcohol, lauryl, myristyl, cetyl, or stearyl alcohol, or of the C₁₀-C₂₀ oxo alcohols, and those semi-esters of secondary alcohols of those chain lengths. Also preferred are alk(en)yl sulfates of the aforesaid chain length that contain a synthetic straight-chain alkyl residue produced on a petrochemical basis, which possess a breakdown behavior analogous to those appropriate compounds based on fat-chemistry raw materials. For purposes of washing technology, the C₁₂-C₁₆ alkyl sulfates and C₁₂-C₁₅ alkyl sulfates, as well as C₁₄-C₁₅ alkyl sulfates, are preferred. 2,3-Alkyl sulfates that can be obtained as commercial products of the Shell Oil Company under the name DAN® are also suitable anionic surfactants.

The sulfuric acid monoesters of straight-chain or branched C₇₋₂₁ alcohols ethoxylated with 1 to 6 mol ethylene oxide, such as 2-methyl-branched C₉₋₁₁ alcohols having an average of 3.5 mol ethylene oxide (EO) or C₁₂₋₁₈ fatty alcohols having 1 to 4 EO, are also suitable.

Other suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, preferably fatty alcohols, and in particular ethoxylated fatty alcohols. Preferred sulfosuccinates contain C₈₋₁₈ fatty alcohol residues or mixtures thereof. Particularly preferred sulfosuccinates contain a fatty alcohol residue that is derived from ethoxylated fatty alcohols that, considered per se, represent nonionic surfactants (see description below). Sulfosuccinates whose fatty alcohol residues derive from ethoxylated fatty alcohols having a restricted homolog distribution are, in turn, particularly preferred. It is likewise also possible to use alk(en)ylsuccinic acid having by preference 8 to 18 carbon atoms in the alk(en)yl chain, or salts thereof.

Further anionic surfactants include fatty acid soaps. Saturated and unsaturated fatty acid soaps, such as the salts of lauric acid, myristic acid, palmitic acid, stearic acid, (hydrogenated) erucic acid, and behenic acid, are suitable, as are soap mixtures derived in particular from natural fatty acids (e.g., coconut, palm-kernel, olive-oil, or tallow fatty acids).

Fatty acid soaps can, however, negatively influence the foaming capability of the washing or cleaning agents. It is therefore preferred that the washing or cleaning agent contains only small quantities of fatty acid soap, by preference less than 1 wt %, and more preferably less than 0.5 wt %, based on the entire washing or cleaning agent. In a particularly preferred embodiment, the washing or cleaning agent according to the present invention is free of fatty acid soaps.

Anionic surfactants, including the soaps, can be present in the form of their sodium, potassium, or ammonium salts and as soluble salts of organic bases, such as mono-, di-, or triethanolamine. The anionic surfactants are preferably present in the form of their sodium or potassium salts, in particular in the form of the sodium salts.

Anionic surfactant content of preferred washing or cleaning agents is 2 to 30 wt %, by preference 4 to 25 wt %, and in particular 5 to 22 wt %, each based on the entire washing or cleaning agent.

Preferred washing or cleaning agents contain in the surfactant mixture a combination of sulfonates and sulfates. Very particularly preferably, the surfactant mixture contains C₉₋₁₃ alkylbenzenesulfonates and ethoxylated fatty alcohol sulfates.

In order to obtain washing or cleaning agents according to the present invention (i.e., high-foaming liquid washing or cleaning agents having optimum viscosity for utilization in hand laundering), it is essential that the ratio of anionic surfactant to electrolyte be higher than 10:1. Particularly advantageous washing or cleaning agents are obtained when the ratio of anionic surfactant to electrolyte is higher than 12:1, and very particularly preferably higher than 15:1.

The washing or cleaning agent further contains a foam booster. The term “foam booster” embraces, in the context of this invention, compounds that intensify the foaming properties of the further ingredients of the washing or cleaning agent, in particular of the surfactants.

Alkylaminocarboxylic acid salts, fatty acid amides, fatty acid alkanolamides, betaines, sulfobetaines, polymeric compounds, or mixtures thereof are used by preference as foam boosters in the washing or cleaning agents. A foam booster that is preferred for use is an alkylaminocarboxylic acid salt, and in particular the sodium salt of N-(carboxyethyl)-N-dodecyl-beta-alanine. The latter compound can be obtained, for example, as Tensan® VS from Polygon.

It has also been found that the foam behavior of the liquid washing or cleaning agent can be further intensified by the addition of monopropylene glycol. The monopropylene glycol can be used alone or in a mixture with other solvents, for example ethanol. A preferred mixture for intensifying the foam behavior is a 1:1 mixture of monopropylene glycol and ethanol. The quantity of monopropylene glycol (mixture) is by preference between 0.5 and 5 wt %, and particularly preferably between 1 and 2 wt %.

In addition to the surfactant mixture of anionic surfactant and APG, the electrolyte, and the foam booster, a washing or cleaning agent can contain further ingredients that further improve the applications-engineering or aesthetic properties of the washing or cleaning agent. In the context of the present invention, the washing or cleaning agent by preference additionally contains one or more substances from the group of the nonionic surfactants, detergency builders, bleaching agents, enzymes, nonaqueous solvents, pH adjusting agents, perfumes, perfume carriers, fluorescing agents, dyes, hydrotopes, silicone oils, anti-redeposition agents, anti-gray agents, shrinkage preventers, wrinkle protection agents, color transfer inhibitors, antimicrobial active substances, germicides, fungicides, antioxidants, preservatives, corrosion inhibitors, antistatic agents, bittering agents, ironing adjuvants, proofing and impregnation agents, swelling and anti-slip agents, softening compounds, and UV absorbers.

Nonionic surfactants used are by preference alkoxylated, advantageously ethoxylated, in particular primary alcohols having by preference 8 to 18 carbon atoms and an average of 1 to 12 mol ethylene oxide (EO) per mol of alcohol, wherein the alcohol residue can be linear or preferably methyl-branched in the 2-position, or can contain mixed linear and methyl-branched residues such as those that are usually present in oxo alcohol residues. Particularly preferred, however, are alcohol ethoxylates having linear residues made up of alcohols of natural origin having 12 to 18 carbon atoms (e.g., from coconut, palm, tallow, or oleyl alcohol), and an average of 2 to 8 EO per mol of alcohol. Preferred ethoxylated alcohols include, for example, C₁₂₋₁₄ alcohols with 3 EO, 4 EO, 5 EO, or 7 EO; C₉₋₁₁ alcohols with 7 EO; C₁₃₋₁₅ alcohols with 3 EO, 5 EO, 7 EO, or 8 EO; C₁₂₋₁₈ alcohols with 3 EO, 5 EO, or 7 EO; and mixtures thereof, such as mixtures of C₁₂₋₁₄ alcohol with 3 EO and C₁₂₋₁₈ alcohol with 7 EO. The degrees of ethoxylation indicated represent statistical averages, which can correspond to an integral or a fractional number for a specific product. Preferred alcohol ethoxylates exhibit a restricted distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO. Nonionic surfactants that contain EO and PO groups together in the molecule are also usable according to the present invention. Block copolymers having EO-PO block units or PO-EO block units, but also EO-PO-EO copolymers or PO-EO-PO copolymers, can be used in this context. Also usable, of course, are mixed alkoxylated nonionic surfactants in which EO and PO units are distributed statistically rather than in block fashion. Such products are obtainable by the simultaneous action of ethylene oxide and propylene oxide on fatty alcohols. These nonionic surfactants are obtainable, for example, under the commercial name Dehydrol® (from Cognis), Dehydrol® 980 being preferred.

Further classes of nonionic surfactants used in preferred fashion, which are used either as the only nonionic surfactant or in combination with other nonionic surfactants, are alkoxylated, preferably ethoxylated or ethoxylated and propoxylated fatty acid alkyl esters, by preference, having 1 to 4 carbon atoms in the alkyl chain, in particular fatty acid methyl esters.

Nonionic surfactants of the amine oxide type, for example N-cocalkyl-N,N-dimethylamine oxide and N-tallowalkyl-N,N-dihydroxyethylamine oxide, can also be suitable. The quantity of these nonionic surfactants is by preference no more than that of the ethoxylated fatty alcohols, in particular no more than half thereof.

Further suitable surfactants are polyhydroxy fatty acid amides of formula (I)—

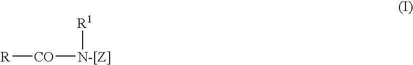

wherein RCO is an aliphatic acyl residue having 6 to 22 carbon atoms; R′ is hydrogen, an alkyl or hydroxyalkyl residue having 1 to 4 carbon atoms; and [Z] is a linear or branched polyhydroxyalkyl residue having 3 to 10 carbon atoms and 3 to 10 hydroxyl groups. The polyhydroxy fatty acid amides are known substances, usually obtained by reductive amination of a reducing sugar with ammonia, an alkylamine, or an alkanolamine, and subsequent acylation with a fatty acid, a fatty acid alkyl ester, or a fatty acid chloride.

Also belonging to the group of the polyhydroxy fatty acid amides are compounds of formula (II)—

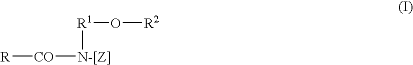

wherein R is a linear or branched alkyl or alkenyl residue having 7 to 12 carbon atoms; R¹ is a linear, branched, or cyclic alkyl residue or an aryl residue having 2 to 8 carbon atoms; and R² is a linear, branched, or cyclic alkyl residue or an aryl residue or an oxyalkyl residue having 1 to 8 carbon atoms, C₁₋₄ alkyl or phenyl residues being preferred; and [Z] is a linear polyhydroxyalkyl residue whose alkyl chain is substituted with at least two hydroxyl groups, or alkoxylated, preferably ethoxylated or propoxylated, derivatives of that residue.

[Z] is preferably obtained by reductive amination of a sugar, for example, glucose, fructose, maltose, lactose, galactose, mannose, or xylose. The N-alkoxy- or N-aryloxy-substituted compounds can then be converted into the desired polyhydroxy fatty acid amides by reaction with fatty acid methyl esters in the presence of an alkoxide as catalyst.

The concentration of nonionic surfactants in the washing or cleaning agent is preferably 1 to 30 wt %, by preference 2 to 20 wt %, and in particular 3 to 15 wt %, each based on the washing or cleaning agent.

The total surfactant concentration of the liquid washing or cleaning agent is by preference below 60 wt %, and particular preferably below 45 wt %, based on the entire liquid washing or cleaning agent.

Silicates, aluminum silicates (in particular zeolites), carbonates, salts of organic di- and polycarboxylic acids, and mixtures of these substances, may be mentioned in particular as detergency builders that can be contained in the washing or cleaning agent.

Suitable crystalline, sheet-form sodium silicates possess the general formula NaMSiₓO₂ₓ₊₁.H₂O, wherein M denotes sodium or hydrogen, x is a number from 1.9 to 4, and y is a number from 0 to 20, and preferred values for x are 2, 3, or 4. Preferred crystalline sheet silicates of the formula indicated above are those in which M denotes sodium and x assumes the value 2 or 3. Both β- and δ-sodium disilicates Na₂Si₂O₅.yH₂O are particularly preferred.

Also usable are amorphous sodium silicates having a Na₂O:SiO₂ modulus from 1:2 to 1:3.3, preferably from 1:2 to 1:2.8, and in particular from 1:2 to 1:2.6, which are dissolution-delayed and exhibit secondary washing properties. The dissolution delay as compared with conventional amorphous sodium silicates can be brought about in various ways, for example, by surface treatment, compounding, compacting/densification, or overdrying. In the context of this invention, the term “amorphous” is also understood to mean “X-amorphous”. In other words, in X-ray diffraction experiments the silicates do not yield the sharp X-ray reflections typical of crystalline substances, but, at most, one or more maxima in the scattered X radiation that have a width of several degree units of the diffraction angle. Particularly good builder properties can, however, be obtained very easily even if the silicate particles yield blurred or even sharp diffraction maxima in electron beam diffraction experiments. This may be interpreted to mean that the products comprise microcrystalline regions 10 to several hundred nm in size, with values of up to a maximum of 50 nm, and in particular a maximum of 20 nm, being preferred. Densified/compacted amorphous silicates, compounded amorphous silicates, and overdried X-amorphous silicates are particularly preferred.

Useful finely crystalline synthetic zeolite containing bound water includes, by preference, zeolite A and/or zeolite P. Zeolite MAP® (commercial product of the Crosfield Co.) is particularly preferred as zeolite P. Also suitable, however, are zeolite X as well as mixtures of A, X, and/or P. Also commercially available and preferably usable in the context of the present invention is, for example, a co-crystal of zeolite X and zeolite A (approx. 80 wt % zeolite X) that is marketed by the Sasol company under the trade name VEGOBOND AX® and can be described by the formula

nNa₂O.(1−n)K₂O.Al₂O₃.(2−2.5)SiO₂.(3.5−5.5)H₂O
n=0.90−1.0.

The zeolite can be used as a spray-dried powder or also as an undried stabilized suspension still moist as manufactured. In the event the zeolite is used as a suspension, it can contain small additions of nonionic surfactants as stabilizers, for example 1 to 3 wt %, based on the zeolite, of ethoxylated C₁₂-C₁₈ fatty alcohols having 2 to 5 ethylene oxide groups, C₁₂-C₁₄ fatty alcohols having 4 to 5 ethylene oxide groups, or ethoxylated isotridecanols. Suitable zeolites exhibit an average particle size of less than 10 μm (volume distribution; measurement method: Coulter Counter), and contain by preference 18 to 22 wt %, in particular 20 to 22 wt %, bound water.

Use of commonly known phosphates as builder substances is also possible, of course, provided such use should not be avoided for environmental reasons. Sodium salts of the orthophosphates, pyrophosphates, and, in particular, tripolyphosphates are particularly suitable.

Organic builder substances that can be present in the washing or cleaning agent are, for example, the polycarboxylic acids usable in the form of their sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), and their descendants, as well as mixtures thereof. Preferred salts are the salts of the polycarboxylic acids such as citric acid, adipic acid, succinic acid, glutaric acid, tartaric acid, sugar acids, and mixtures thereof.

Acids per se can also be used. Acids typically possess not only their builder effect but also the property of an acidifying component, and thus serve also to establish a lower and milder pH for washing or cleaning agents. Citric acid, succinic acid, glutaric acid, adipic acid, gluconic acid, and any mixtures thereof are inlcuded in particular in this context. Further known pH regulators are sodium hydrogencarbonate and sodium hydrogensulfate.

Polymeric polycarboxylates are also suitable as builders. These are, for example, the alkali metal salts of polyacrylic acid or of polymethacrylic acid (e.g., those having a relative molecular weight from 500 to 70,000 g/mol).

Molar weights indicated for the polymeric polycarboxylates are, for purposes of this document, weight-averaged molar weights M_{w} of the respective acid form determined by gel permeation chromatography (GPC), with a UV detector having been used. The measurement was performed against an external polyacrylic acid standard that yields realistic molecular weight values because of its structural affinity with the polymers being investigated. These indications deviate considerably from the molecular weight indications in which polystyrenesulfonic acids are used as a standard. The molar weights measured against polystyrenesulfonic acids are usually much higher than the molar weights indicated in this document.

Suitable polymers are, in particular, polyacrylates that preferably have a molecular weight from 2000 to 20,000 g/mol. Of this group, the short-chain polyacrylates that have molar weights from 2000 to 10,000 g/ml, and particularly preferably from 3000 to 5000 g/mol, may be preferred because of their superior solubility.

Suitable polymers can also encompass substances that are made up partly or entirely of units of vinyl alcohol or derivatives thereof.

Copolymeric polycarboxylates, in particular, those of acrylic acid with methacrylic acid and of acrylic acid or methacrylic acid with maleic acid, are also suitable. Copolymers of acrylic acid with maleic acid that contain 50 to 90 wt % acrylic acid and 50 to 10 wt % maleic acid have proven particularly suitable. Their relative molecular weight, based on free acids, is generally 2000 to 70,000 g/mol, by preference 20,000 to 50,000 g/mol, and in particular 30,000 to 40,000 g/mol. The (co)polymeric polycarboxylates can be used either as an aqueous solution or preferably as a powder.

To improve water solubility, the polymers can also contain allylsulfonic acids, such as allyloxybenzenesulfonic acid and methallylsulfonic acid, as monomers.

Also particularly preferred are biodegradable polymers made up of more than two different monomer units, for example those that contain as monomers salts of acrylic acid and of maleic acid as well as vinyl alcohol or vinyl alcohol derivatives, or, as monomers, salts of acrylic acid and of 2-alkylallylsulfonic acid, as well as sugar derivatives.

Further preferred copolymers are those that preferably comprise acrolein and acrylic acid/acrylic acid salts, or acrolein and vinyl acetate, as monomers.

Also to be mentioned as further preferred detergency builders are polymeric aminodicarboxylic acids, salts thereof, or precursor substances thereof. Polyaspartic acids and salts and derivatives thereof, which also have a bleach-stabilizing action in addition to builder properties, are particularly preferred.

Further suitable builder substances are polyacetals, which can be obtained by reacting dialdehydes with polyolcarboxylic acids comprising 5 to 7 carbon atoms and at least three hydroxyl groups. Preferred polyacetals are obtained from dialdehydes such as glyoxal, glutaraldehyde, terephthalaldehyde and mixtures thereof, and from polyolcarboxylic acids such as gluconic acid and/or glucoheptonic acid.

Further suitable organic builder substances include dextrins, for example, oligomers or polymers of carbohydrates, which can be obtained by partial hydrolysis of starches. The hydrolysis can be carried out in accordance with usual methods (e.g., acid- or enzyme-catalyzed). These are by preference hydrolysis products having average molar weights in the range from 400 to 500,000 g/mol. A polysaccharide having a dextrose equivalent (DE) in the range from 0.5 to 40, in particular from 2 to 30, is preferred, DE being a common indicator of the reducing effect of a polysaccharide as compared with dextrose, which possesses a DE of 100. Both maltodextrins having a DE between 3 and 20 and dry glucose syrups having a DE between 20 and 37, as well as so-called yellow dextrins and white dextrins having higher molar weights in the range from 2000 to 30,000 g/mol, are usable.

The oxidized derivatives of such dextrins are their reaction products with oxidizing agents that are capable of oxidizing at least one alcohol function of the saccharide ring to the carboxylic acid function. An oxidized oligosaccharide is likewise suitable. A product oxidized at C₆ of the saccharide ring can be particularly advantageous.

Oxydisuccinates and other derivatives of disuccinates, by preference ethylenediamine disuccinate, are also additional suitable detergency builders. Ethylenediamine-N,N-disuccinate (EDDS) is used here, preferably in the form of its sodium or magnesium salts. Also preferred in this context are glycerol disuccinates and glycerol trisuccinates.

Other usable organic detergency builders are, for example, acetylated hydroxycarboxylic acids and their salts, which can optionally also be present in lactone form and which contain at least 4 carbon atoms and at least one hydroxy group, as well as a maximum of two acid groups.

Among the compounds that serve as bleaching agents and yield H₂O₂ in water, sodium perborate tetrahydrate and sodium perborate monohydrate are particularly important. Other usable bleaching agents are, for example, sodium percarbonate, peroxypyrophosphates, citrate perhydrates, and peracid salts or peracids that yield H₂O₂, such as perbenzoates, peroxophthalates, diperazelaic acid, diperdodecanedioic acid, 4-phthalimidoperoxobutanoic acid, 5-phthalimidoperoxopentanoic acid, 6-phthalimidoperoxohexanoic acid, 7-phthalimidoperoxoheptanoic acid, N,N′-terephthaloyldi-6-aminoperoxohexanoic acid, and mixtures thereof. The phthalimidoperoxoalkanoic acids, in particular 6-phthalimidoperoxohexanoic acid (PAP), are among the preferred peracids. It may be preferred for the bleaching agent to comprise a casing that dissolves only in the actual washing process and then releases the bleaching agent.

The quantity of bleaching agent is by preference between 0.5 and 25 wt %, based on the entire washing or cleaning agent.

In order to achieve an improved bleaching effect when washing at temperatures of 60° C. and below, bleach activators can be incorporated into the washing and cleaning agents. Compounds that yield aliphatic peroxycarboxylic acids under perhydrolysis conditions can be used as bleach activators. Multiply acylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic acid anhydrides, in particular phthalic acid anhydride, acylated polyvalent alcohols, in particular triacetin, ethylene glycol diacetate, and 2,5-diacetoxy-2,5-dihydrofuran, are preferred.

In addition to or instead of the conventional bleach activators, so-called bleach catalysts can also be incorporated into the liquid washing or cleaning agents. These substances are bleach-enhancing transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru amine complexes, are also usable as bleach catalysts. Also suitable are so-called “photobleaches” based on modified TiO₂, which are activated by the action of light.

Alternatively or additionally, the liquid washing or cleaning agent can also contain a photobleaching agent. Preferred photobleaching agents include metal-phthalocyanine compounds obtainable, for example, from Ciba under the designation Tinolux®. The quantity of photobleaching agent in a liquid washing or cleaning agent is by preference 0.0005 to 0.1 wt %, more preferably 0.001 to 0.075 wt %, and most preferably 0.005 to 0.05 wt %.

The washing or cleaning agent can contain a thickening agent. The thickening agent can encompass, for example, a (meth)acrylic (co)polymer, xanthan gum, gellan gum, guar flour, alginate, carrageenan, carboxymethyl cellulose, bentonite, wellan gum, locust bean flour, agar-agar, tragacanth, gum arabic, pectins, polyoses, starch, dextrins, gelatins, and casein. Modified natural substances such as modified starches and celluloses can, however, also be used as thickening agents; examples that may be cited here are carboxymethyl cellulose and other cellulose ethers, hydroxyethyl and -propyl cellulose, and seed flour ethers.

Suitable acrylic and methacrylic (co)polymers encompass, for example, the high-molecular-weight homopolymers of acrylic acid crosslinked with a polyalkenyl polyether, in particular an allyl ether, of sucrose, pentaerythritol, or propylene (INCI name, according to “International Dictionary of Cosmetic Ingredients” of the Cosmetic, Toiletry and Fragrance Association (CFTA): Carbomer), which are also referred to as carboxyvinyl polymers. Polyacrylic acids of this kind are obtainable from, among others, the 3V Sigma company under the trade name Polygel®, e.g. Polygel® DA, and from the B.F. Goodrich company under the trade name Carbopol®, e.g. Carbopol® 940 (molecular weight approx. 4,000,000), Carbopol® 941 (molecular weight approx. 1,250,000), or Carbopol® 934 (molecular weight approx. 3,000,000). Also suitable, for example, are the following acrylic acid copolymers: (i) copolymers of two or more monomers from the group of acrylic acid, methacrylic acid, and their simple esters, formed by preference with C₁₋₄ alkanols Acrylates Copolymer), included among which are, for example, the copolymers of methacrylic acid, butyl acrylate, and methyl methacrylate (CAS designation according to Chemical Abstracts Service: 25035-69-2), or of butyl acrylate and methyl methacrylate (CAS 25852-37-3), and which are obtainable, for example, from the Rohm & Haas company under the trade names Aculyn® and Acusol®, and from the Degussa (Goldschmidt) company under the trade name Tego® Polymer, e.g. the anionic nonassociative polymers Aculyn® 22, Aculyn® 28, Aculyn® 33 (crosslinked), Acusol® 810, Acusor 820, Acusol® 823, and Acusol® 830 (CAS 25852-37-3); (ii) crosslinked high-molecular-weight acrylic acid copolymers, included among which are, for example, the copolymers, crosslinked with an allyl ether of sucrose or of pentaerythritol, of C₁₀₋₃₀ alkyl acrylates with one or more monomers from the group of acrylic acid, methacrylic acid, and their simple esters formed preferably with C₁₋₄ alkanols Acrylates/C₁₀₋₃₀ Alkyl Acrylate Crosspolymer), and which are obtainable, for example, from the B.F. Goodrich company under the trade name Carbopol® (e.g., the hydrophobized Carbopol® ETD 2623 and Carbopol® 1382 (INCI: Acrylates/C₁₀₋₃₀ Alkyl Acrylate Crosspolymer), and Carbopol® Aqua 30 (formerly Carbopol EX 473)). Further suitable polymers are (meth)acrylic acid (co)polymers of the Sokalan® type (from BASF), for example Sokalan® AT 10.

Fatty alcohols are also a suitable thickening agent. Fatty alcohols can be branched or unbranched, and of natural or petrochemical origin. Preferred fatty alcohols have a carbon chain length from 10 to 20 carbon atoms, preferably 12 to 18. It is preferred to use mixtures of different carbon chain lengths, such as tallow fatty alcohol or coconut fatty alcohol. Examples are Lorol® Spezial (C₁₂₋₁₄—ROH) or Lorol® Technisch (C₁₂₋₁₈—ROH) (both from Cognis).

The washing or cleaning agent can contain 0.01 to 3 wt %, and by preference 0.1 to 1 wt %, thickening agent. The quantity of thickening agent used depends on the type of thickening agent and the desired degree of thickening. Preferred washing or cleaning agents, however, contain no thickening agent.

The washing or cleaning agent can contain enzymes. Suitable enzymes include, in particular, those from the classes of hydrolases, such as proteases, (poly)esterases, lipases or lipolytically active enzymes, amylases, cellulases and other glycosyl hydrolases, hemicellulase, cutinases, β-glucanases, oxidases, peroxidases, mannanases, tannases, perhydrolases, and/or laccases, and mixtures of the aforesaid enzymes. All these hydrolases contribute, in the laundry, to the removal of stains such as protein-, fat-, or starch-containing stains, and graying. Cellulases and other glycosyl hydrolases can furthermore contribute to color retention and enhanced textile softness by removing pilling and microfibrils. Oxidoreductases can also be used for bleaching and to inhibit color transfer. Enzymatic active substances obtained from bacterial strains or fungi, such as Bacillus subtilis, Bacillus lichenifonnis, Streptomyceus griseus, and Humicola insolens, are particularly suitable. Proteases of the subtilisin type, and in particular proteases obtained from Bacillus lentus, are preferably used. Enzyme mixtures, for example, of protease and amylase or protease and lipase or lipolytically active enzymes, or protease and cellulase, or of cellulase and lipase or lipolytically active enzymes, or of protease, amylase, and lipase or lipolytically active enzymes, or protease, lipase or lipolytically active enzymes, and cellulase, but in particular protease- and/or lipase-containing mixtures or mixtures with lipolytically active enzymes, are of particular interest in this context. Examples of such lipolytically active enzymes are the known cutinases. Peroxidases or oxidases have also proven suitable in some cases. The suitable amylases include, in particular, α-amylases, isoamylases, pullulanases, and pectinases. Cellobiohydrolases, endoglucanases, and β-glucosidases, which are also called cellobiases, and mixtures thereof, are preferably used as cellulases. Because the different types of cellulase differ in terms of their CMCase and avicelase activities, the desired activities can be adjusted by means of controlled mixtures of the cellulases.

The enzymes can be encapsulated or adsorbed onto carrier substances in order to protect them from premature decomposition. The proportion of enzymes, enzyme formulation(s), or enzyme granulates in a washing or cleaning agent can be, for example, approximately 0.01 to 5 wt %, by preference 0.12 to approximately 2.5 wt %.

Nonaqueous solvents that can be added to the liquid washing and cleaning agent include, for example, monovalent or polyvalent alcohols, alkanolamines, or glycol ethers, provided they are miscible with water in the indicated concentration range. The solvents are by preference chosen from ethanol, n- or isopropanol, butanols, glycol, propane- or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, diisopropylene glycol monomethyl ether, diisopropylene glycol monoethyl ether, methoxytriglycol, ethoxytriglycol, butoxytriglycol, 1-butoxyethoxy-2-propanol, 3-methyl-3-methoxybutanol, propylene glycol t-butyl ether, di-n-octyl ether, and mixtures of these solvents. Nonaqueous solvents can be used in the washing or cleaning agent in quantities between 0.5 and 15 wt %, but preferably below 12 wt % and in particular below 9 wt %.

In a particularly preferred embodiment, the liquid washing or cleaning agent contains monopropylene glycol in order to intensify foam formation. The quantity of monopropylene glycol is by preference between 0.5 and 9 wt %, and more preferably from 1 to 5 wt %.

In order to bring the pH of the washing or cleaning agent into the desired range, the use of pH adjusting agents may be indicated. All known acids and bases are usable here, provided their use is not prohibited for environmental or applications-engineering reasons, or for reasons of consumer safety. The quantity of these adjusting agents usually does not exceed 10 wt % of the entire formulation.

The pH of the washing or cleaning agent is preferably between 4 and 10, and preferably between 5.5 and 8.8.

The liquid washing or cleaning agents have viscosities of less than 10,000 mPas and preferably in the range from 400 to 5000 mPas, values between 800 and 2500 mPas being particularly preferred. The viscosity was determined using a Brookfield LVT-II viscosimeter at 20 rpm and 20° C., spindle 3.

In a preferred embodiment, the washing or cleaning agent contains one or more perfumes in a quantity of usually up to 10 wt %, by preference 0.01 to 5 wt %, in particular 0.3 to 3 wt %.

Individual fragrance compounds (e.g., the synthetic products of the ester, ether, aldehyde, ketone, alcohol, and hydrocarbon types) can be used as perfume oils or scents. Preferably, however, mixtures of different fragrances that together produce an attractive scent note are used. Such perfume oils can also contain natural fragrance mixtures such as those accessible from plant sources.

In order to improve the aesthetic impression of the washing or cleaning agent, they can be colored with suitable dyes. Preferred dyes, the selection of which will present no difficulty whatsoever to one skilled in the art, possess excellent shelf stability and insensitivity to the other ingredients of the washing or cleaning agents and to light, and no pronounced substantivity with respect to textile fibers in order not to color them.

Suitable soil-release polymers (which are also referred to as “anti-redeposition agents”) are, for example, nonionic cellulose ethers such as methyl cellulose and methylhydroxypropyl cellulose having a 15 to 30 wt % concentration of methoxy groups and a 1 to 15 wt % concentration of hydroxypropyl groups, based in each case on the nonionic cellulose ethers, as well as the polymers, known from the existing art, of phthalic acid and/or terephthalic acid or of their derivatives, in particular polymers of ethylene terephthalates and/or polyethylene and/or polypropylene glycol terephthalates or anionically and/or nonionically modified derivatives thereof. Suitable derivatives encompass the sulfonated derivatives of the phthalic acid and terephthalic acid polymers.

Optical brighteners (so-called “whiteners”) can be added to the washing or cleaning agents in order to eliminate graying and yellowing of the treated textile fabrics. These substances absorb onto the fibers and cause brightening and a simulated bleaching effect by converting invisible ultraviolet radiation into visible longer-wave light, the ultraviolet light absorbed from sunlight being emitted as slightly bluish fluorescence and resulting, with the yellow tone of the grayed or yellowed laundry, in pure white. Suitable compounds derive, for example, from the substance classes of the 4,4′-diamino-2,2′-stilbenedisulfonic acids (flavonic acids), 4,4′-distyrylbiphenyls, methylumbelliferones, cumarins, dihydroquinolinones, 1,3-diarylpyrazolines, naphthalic acid imides, benzoxazole, benzisoxazole, and benzimidazole systems, and pyrene derivatives substituted with heterocycles. The optical brighteners are usually used in quantities of between 0 and 0.3 wt % based on the finished washing or cleaning agent.

Anti-gray agents keep suspended in the washing bath dirt that has been detached from the fibers, and thus prevent redeposition of the dirt. Water-soluble colloids, usually organic in nature, are suitable for this, for example, glue, gelatin, salts of ethersulfonic acids of starch or of cellulose, or salts of acid sulfuric acid esters of cellulose or of starch. Water-soluble polyamides containing acid groups are also suitable for this purpose. Soluble starch preparations, and starch products other than those cited above, can also be used, for example degraded starch, aldehyde starches, etc. Polyvinylpyrrolidone is also usable. It is preferred, however, to use cellulose ethers such as carboxymethyl cellulose (Na salt), methyl cellulose, hydroxyalkyl cellulose, and mixed ethers such as methylhydroxyethyl cellulose, methylhydroxypropyl cellulose, methylcarboxymethyl cellulose, and mixtures thereof, in quantities from 0.1 to 5 wt % based on total quantity of washing or cleaning agent.

In order effectively to suppress dye dissolution and/or dye transfer onto other textiles during the washing and/or cleaning of colored textiles, the washing or cleaning agent can contain a color transfer inhibitor. It is preferred that the color transfer inhibitor be a polymer or copolymer of cyclic amines such as, for example, vinylpyrrolidone and/or vinylimidazole. Polymers suitable as a color transfer inhibitor encompass polyvinylpyrrolidone (PVP), polyvinylimidazole (PVI), copolymers of vinylpyrrolidone and vinylimidazole (PVP/PVI), polyvinylpyridine-N oxide, poly-N-carboxymethyl-4-vinylpyridium chloride, and mixtures thereof. It is particularly preferred to use polyvinylpyrrolidone (PVP), polyvinylimidazole (PVI), or copolymers of vinylpyrrolidone and vinylimidazole (PVP/PVI) as a color transfer inhibitor. The polyvinylpyrrolidones (PVP) that are used preferably possess an average molecular weight from 2,500 to 400,000, and are available commercially from ISP Chemicals as PVP K 15, PVP K 30, PVP K 60, or PVP K 90, or from BASF as Sokalan® HP 50 or Sokalan® HP 53. The copolymers of vinylpyrrolidone and vinylimidazole (PVP/PVI) that are used preferably have a molecular weight in the range from 5000 to 100,000. A PVP/PVI copolymer is available commercially, for example, from BASF under the designation Sokalan® HP 56.

The amount of color transfer inhibitor, based on total weight of the washing or cleaning agent, is preferably from 0.01 to 2 wt %, by preference from 0.05 to 1 wt %, and more preferably from 0.1 to 0.5 wt %.

Alternatively, enzymatic systems encompassing a peroxidase and hydrogen peroxide or a substance yielding hydrogen peroxide in water can be used as a color transfer inhibitor. The addition of a mediator compound for the peroxidase, for example, an acetosyringone, a phenol derivative, or a phenothiazine or phenoxazine, is preferred in this case. The aforementioned polymeric color transfer inhibitors can additionally be used.

Because textile fabrics, in particular, those made of rayon, viscose, cotton, and mixtures thereof, tend to wrinkle due to the individual fibers being sensitive to bending, kinking, pressing, and squeezing perpendicular to the fiber direction, the washing or cleaning agents can contain synthetic wrinkle-protection agents. These include, for example, synthetic products based on fatty acids, fatty acid esters, fatty acid amides, fatty acid alkylol esters, fatty acid alkylolamides, or fatty alcohols that are usually reacted with ethylene oxide, or products based on lecithin or on modified phosphoric acid esters.

In order to counteract microorganisms, the washing or cleaning agents can contain antimicrobial active substances. A distinction is made here, depending on the antimicrobial spectrum and mechanism of action, between bacteriostatics and bactericides, fungistatics and fungicides, etc. Important substances from these groups are, for example, benzalkonium chlorides, alkylarylsulfonates, halogen phenols, and phenol mercuric acetate; these compounds can also be entirely omitted from the washing or cleaning agents according to the present invention.

The washing or cleaning agents according to the present invention can contain preservatives, preferably only those that possess little or no skin-sensitizing potential being used. Examples are sorbic acid and its salts, benzoic acid and its salts, salicylic acid and its salts, phenoxyethanol, formic acid and its salts, 3-iodo-2-propynylbutyl carbamate, sodium N-(hydroxymethyl) glycinate, biphenyl-2-ol, and mixtures thereof. Further suitable preservatives are represented by isothiazolones, mixtures of isothiazolones, and mixtures of isothiazolones with other compounds, for example tetramethylol glycoluril.

The washing or cleaning agents can contain antioxidants in order to prevent undesired changes caused by the action of oxygen and other oxidative processes to the washing or cleaning agents and/or to the treated textile fabrics. This class of compounds includes, for example, substituted phenols, hydroquinones, catechols, and aromatic amines, as well as organic sulfides, polysulfides, dithiocarbamates, phosphites, phosphonates, and vitamin E.

Increased wearing comfort can result from the additional use of antistatic agents that are additionally added to the washing or cleaning agents. Antistatic agents increase the surface conductivity and thus make possible improved dissipation of charges that have formed. External antistatic agents are usually substances having at least one hydrophilic molecule ligand, and yield a more or less hygroscopic film on the surfaces. These usually surface-active antistatic agents can be subdivided into nitrogen-containing (amines, amides, quaternary ammonium compounds), phosphorus-containing (phosphoric acid esters), and sulfur-containing (alkylsulfonates, alkyl sulfates) antistatic agents. Lauryl- (or stearyl-)dimethylbenzylammonium chlorides are suitable as antistatic agents for textiles or as an additive to washing or cleaning agents, a brightening effect additionally being achieved.

In order to improve the rewettability of the treated textile fabrics and to facilitate ironing of the treated textile fabrics, silicone derivatives can be used in the washing or cleaning agents. Preferred silicone derivatives include, for example, polydialkyl- or alkylarylsiloxanes in which the alkyl groups have one to five carbon atoms and are entirely or partly fluorinated. Preferred silicones are polydimethylsiloxanes, which optionally can be derivatized and are then aminofunctional or quaternized or have Si—OH, Si—H, and/or Si—Cl bonds. The viscosities of the preferred silicones are in the range between 100 and 100,000 mPas at 25° C.; the silicones can be used in quantities between 0.2 and 5 wt % based on the entire quantity of washing or cleaning agent. Because of their foam-inhibiting properties, however, the use and quantity of silicone compounds in the washing or cleaning agents that are high-foaming according to the present invention should be carefully considered. Preferred washing or cleaning agents contain no silicone compounds.

Lastly, the washing or cleaning agent can also contain UV absorbers, which are absorbed onto the treated textile fabrics and improve the light-fastness of the fibers. Compounds that exhibit these desired properties include, for example, compounds that act by radiationless deactivation, and derivatives of benzophenone having substituents in the 2- and/or 4-position. Also suitable are substituted benzotriazoles, acrylates phenyl-substituted in the 3-position (cinnamic acid derivatives) optionally having cyano groups in the 2-position, salicylates, organic Ni complexes, and natural substances such as umbelliferone and endogenous urocanic acid.

Substances that complex heavy metals can be used in order to avoid the heavy-metal-catalyzed breakdown of certain washing-agent ingredients. Suitable heavy metal complexing agents are, for example, the alkali salts of ethylenediaminetetraacetic acid (EDTA) or of nitrilotriacetic acid (NTA), methylglycinediacetic acid trisodium salt (MGDA), as well as alkali-metal salts of anionic polyelectrolytes such as polymaleates and polysulfonates.

A preferred class of complexing agents is phosphonates, which are contained in the washing or cleaning agent in quantities from 0.01 to 2.5 wt %, by preference 0.02 to 2 wt %, and in particular from 0.03 to 1.5 wt %. Among these preferred compounds are, in particular, organophosphonates such as 1-hydroxyethane-1,1-diphosphonic acid (HEDP), aminotri(methylenephosphonic acid) (ATMP), diethylenetriamine penta(methylenephosphonic acid) (DTPMP or DETPMP), and 2-phosphonobutane-1,2,4-tricarboxylic acid (PBS-AM), which are usually used in their ammonium or alkali-metal salt form. Alternative complexing agents that can be used in the washing or cleaning agent are iminodisuccinates (IDS) or ethylenediamine-N,N′-disuccinate (EDDS).

Washing or cleaning agents according to the present invention can be used to wash and/or clean textile fabrics.

The washing or cleaning agent is manufactured according to usual and known methods and processes. For example, the constituents of the washing or cleaning agents can be simply mixed in agitator vessels, the water, nonaqueous solvent, and surfactants typically being prepared first. The fatty acid component, if present, is then saponified at 50 to 60° C. Additional constituents, including the foam booster and electrolyte, are then added in portions.

Table 1 below shows the compositions of three washing or cleaning agents E1 to E3 according to the present invention, and of two comparative examples V1 and V2. Quantities are indicated in wt %.

TABLE 1

| | E1 | E2 | E3 | V1 | V2 |
|---|---|---|---|---|---|
| C₁₂-alkylbenzenesulfonic acid, Na salt | 4 | 4 | 4 | 4 | 4 |
| Sodium lauryl ether sulfate with 2 EO | 9 | 9 | 9 | 9 | 9 |
| C₁₂₋₁₄ alkylpolyglucoside (x = 1.4) | 2 | 2 | 2 | 2 | 2 |
| NaCl | 0.8 | 1 | 1.2 | 1.4 | 2 |
| Foam booster* | 1 | 1 | 1 | 1 | 1 |
| Phosphonic acid | 0.2 | 0.2 | 0.2 | 0.2 | 0.2 |
| Optical brightener | 0.05 | 0.05 | 0.05 | 0.05 | 0.05 |
| Enzymes, dyes, preservatives | + | + | + | + | + |
| Perfume | 0.4 | 0.4 | 0.4 | 0.4 | 0.4 |
| Water | to 100 | to 100 | to 100 | to 100 | to 100 |

*Sodium salt of N-(carboxyethyl)-N-dodecyl-beta-alanine (Tensan ® VS from Polygon)
The pH of the compositions was between 8 and 8.4.

Table 2 shows the respective ratios of the individual essential ingredients, and viscosity values (determined with a Brookfield LVT-II viscosimeter at 20 rpm- and 20° C., spindle 3), for the washing or cleaning agents E1 to E3 and V1 and V2.

TABLE 2

| | E1 | E2 | E3 | V1 | V2 |
|---|---|---|---|---|---|
| Anionic surfactant:electrolyte | 16.3:1 | 13:1 | 10.8:1 | 9.3:1 | 6.5:1 |
| Foam booster:electrolyte | 1:0.8 | 1:1 | 1:1.2 | 1:1.4 | 1:2 |
| APG:electrolyte | 2.5:1 | 2:1 | 1.7:1 | 1.4:1 | 1:1 |
| Viscosity (mPas) | 2255 | 4880 | 9040 | 13800 | 16660 |

It is evident from Table 2 that when the ratio of anionic surfactant to electrolyte falls below 10:1, the result is washing or cleaning agents with very high viscosity. As a result, washing or cleaning agents V1 and V2 were not usable for hand laundering of textiles.

Washing or cleaning agents E1 and E2, in particular, exhibited good foam behavior. A determination of foam behavior for both agents using the Wagner method, for example, yielded in each case between 110 and 120 ml of foam that was stable for 5 minutes.

The determination of foaming capability for the washing or cleaning agents was performed in a Wagner apparatus.

For this, test solutions of a defined concentration were foamed under defined conditions in a Wagner unit (Wagner shaker apparatus, model 214/8 PM 1 72-35, Guwina-Hoffmann GmbH), and measured. Firstly, 100 g of each test solution, containing 2 g of the washing agent to be investigated, was produced and transferred into a 1000 ml measurement cylinder. The measurement cylinder was then clamped into the Wagner unit and “shaken” at a rate of 100+/−2 rpm. The foam height was determined 30 seconds after motor shutoff, and after 1 min, 3 min, and 5 min. The foam located above the test solution was determined.

Table 3 below indicates the compositions of two further washing or cleaning agents E4 and E5 according to the present invention. Quantities are indicated in wt %.

TABLE 2

| | E4 | E5 |
|---|---|---|
| C₁₂-alkylbenzenesulfonic acid, Na salt | 4 | 4 |
| Sodium lauryl ether sulfate with 2 EO | 9 | 9 |
| C₁₂₋₁₄ alkylpolyglucoside (x = 1.4) | 2 | 2 |
| NaCl | 1 | 1 |
| Foam booster* | 1 | 1 |
| Ethanol | — | 1 |
| Monopropylene glycol | 2 | 1 |
| Phosphonic acid | 0.2 | 0.2 |
| Optical brightener | 0.05 | 0.05 |
| Enzymes, dyes, preservatives | + | + |
| Perfume | 0.4 | 0.4 |
| Water | to 100 | to 100 |
| Viscosity (mPas) | 2975 | 1550 |
| pH | 8 | 8 |

*Sodium salt of N-(carboxyethyl)-N-dodecyl-beta-alanine (Tensan ® VS from Polygon)

A determination of foam behavior using the Wagner method yielded, for each of the washing or cleaning agents E4 and E5, approximately 150 ml of foam that was stable for 5 minutes.

The addition of 2 wt % monopropylene glycol and 1 wt % ethanol or 2 wt % ethanol resulted in agents whose foam behavior was between 130 and 140 ml (determined by the Wagner method).

The addition of 0.01 wt % of the photobleaching agent Tinolux® BBS (from Ciba) resulted in considerably improved cleaning performance on bleachable stains (e.g., tea stains) with all the washing or cleaning agents E1 to E5 according to the present invention, with no negative influence on the foam behavior or viscosity of the washing or cleaning agents E1 to E5 according to the present invention.

We claim:

1. Liquid washing or cleaning agent comprising a surfactant mixture having at least one anionic surfactant and an alkylpolyglucoside (APG), a foam booster, and an electrolyte, wherein the ratio of anionic surfactant to electrolyte is greater than 10:1.

2. Liquid washing or cleaning agent of claim 1, wherein the ratio of anionic surfactant to electrolyte is greater than 12:1.

3. Liquid washing or cleaning agent of claim 1, wherein the ratio of foam booster to electrolyte is from 1:2 to 1:0.5.

4. Liquid washing or cleaning agent of claim 1, wherein the ratio of APG to electrolyte is from 1:1 to 5:1.

5. Liquid washing or cleaning agent of claim 1, wherein the electrolyte is chosen from alkali metal compounds, alkaline-earth metal compounds, ammonium compounds, and mixtures thereof.

6. Liquid washing or cleaning agent of claim 1, wherein the electrolyte is chosen from organic alkali metal salts, inorganic alkali metal salts, organic alkaline-earth metal salts, inorganic alkaline-earth metal salts, organic ammonium salts, inorganic ammonium salts, and mixtures thereof.

7. Liquid washing or cleaning agent of claim 1, wherein the electrolyte is sodium chloride.

8. Liquid washing or cleaning agent of claim 1, wherein the foam booster is chosen from alkylaminocarboxylic acid salts, fatty acid amides, fatty acid alkanolamides, betaines, sulfobetaines, polymeric compounds, and mixtures thereof.

9. Liquid washing or cleaning agent of claim 1, wherein the foam booster is the sodium salt of N-(carboxyethyl)-N-dodecyl-beta-alanine.

10. Liquid washing or cleaning agent of claim 1, wherein the liquid washing or cleaning agent is free of fatty acid soaps.

11. Liquid washing or cleaning agent of claim 1, the liquid washing or cleaning agent further comprising monopropylene glycol.

12. Liquid washing or cleaning agent of claim 1, the liquid washing or cleaning agent further comprising 0.0005 to 0.1 wt % of a photobleaching agent.
